(19) United States
(12) Patent Application Publication
(10) Pub. No.: US 2018/0097731 A1
(43) Pub. Date: Apr. 5, 2018

(54) COMMUNICATION APPARATUS AND METHOD OF COMMUNICATION

(71) Applicant: FUJITSU LIMITED, Kawasaki-shi (JP)

(72) Inventors: Ryoichi Mutoh, Kawasaki (JP); Naoki OGUCHI, Kawasaki (JP)

(73) Assignee: FUJITSU LIMITED, Kawasaki-shi (JP)

(21) Appl. No.: 15/711,306

(22) Filed: Sep. 21, 2017

(30) Foreign Application Priority Data
Oct. 5, 2016 (JP) 2016-197576

(51) Int. Cl. H04L 12/801; H04L 1/00; H04L 12/853; H04L 12/911; H04L 12/927; H04L 12/26; H04L 29/06

(52) U.S. Cl. CPC H04L 47/10; H04L 1/0002; H04L 47/2416; H04L 65/80; H04L 47/801; H04L 43/0888; H04L 43/0894; H04L 47/745

(57) ABSTRACT

A communication apparatus includes a memory storing relation information indicating a plurality of relationships between a plurality of packet loss rates and a plurality of throughputs of the data included in the packets at the another communication apparatus, and a processor configured to determine a first transmission rate of the packets transmitted from the communication apparatus to the another communication apparatus, a receiving rate of the packets at the another communication apparatus being a maximum value without a packet loss, select a packet loss rate among the plurality of packet loss rates, the throughput of the data corresponding to the selected packet loss rate being under a threshold, based on the first transmission rate and the selected packet loss rate, determine a second transmission rate higher than the first transmission rate, and transmit the packets from the communication apparatus to the another communication apparatus at the second transmission rate.

### CROSS-REFERENCE TO RELATED APPLICATION

This application is based upon and claims the benefit of priority of the prior Japanese Patent Application No. 2016-197576, filed on Oct. 5, 2016, the entire contents of which are incorporated herein by reference.

### FIELD

The embodiments discussed herein are related to a communication apparatus and a method of communication.

### BACKGROUND

To enable efficient communication in a network, a terminal on a transmission end (a transmitting terminal) may measure a transmission rate usable without causing packet loss and perform transmission processing using the transmission rate thus obtained.

FIG. 1 is a diagram illustrating an example of how to measure such a transmission rate. A transmitting terminal 5 transmits packets to a receiving terminal 7 via a network 3 while changing a transmission rate. Graph G1 in FIG. 1 demonstrates the relation between the transmission rate of packets transmitted by the transmitting terminal 5 and the reception rate of the packets received by the receiving terminal 7. The higher the transmission rate, the higher the reception rate at the receiving terminal 7. While this relation is satisfied, the reception rate and the transmission rate are the same value. However, once the transmission rate reaches the transmission rate usable without causing packet loss (the maximum transmission rate), the reception rate is no longer increased by a further increase in the transmission rate because the receiving terminal 7 fails to receive transmitted packets due to packet loss. For this reason, the transmitting terminal 5 transmits packets to the receiving terminal 7 at the maximum transmission rate to avoid packet loss.

As a related art, a method has been proposed which first allocates a minimum requested bandwidth to each of data flows, and then allocates additional bandwidths to the flows from the one with the highest priority level, the additional bandwidths each being the smaller one of the difference between the maximum requested bandwidth and the already-allocated bandwidth and a bandwidth determined based on a currently available bandwidth. Also, a system has been proposed which minimizes data forwarding time by monitoring the bandwidth usage rate of each interface of a physical communication channel and the bandwidth usage rate of each communication flow, and changing a control method to be applied to each communication flow according to these usage rates. Also, a forwarding apparatus has been proposed which calculates an optimum packet length of packets to be sent to a forwarding destination network according to the communication environment and the like of the forwarding destination network, divides packets received from a forwarding source network into packets of the optimum packet length, and sends the divided packets to the forwarding destination network. Furthermore, a system has been designed in which a network manager receives state information on traffic, internode delay time, and the like from a plurality of nodes, and based on the received states, sets optical channels between the nodes such that the network throughput is optimized. The related arts include International Publication Pamphlet No. WO 2006/057381 and Japanese Laid-open Patent Publication Nos. 2012-182605, 2008-153778, and 2000-232483.

### SUMMARY

According to an aspect of the invention, a communication apparatus configured to transmit packets including data to another communication apparatus, the communication apparatus includes a memory configured to store relation information indicating a plurality of relationships between a plurality of packet loss rates at the another communication apparatus and a plurality of throughputs of the data included in the packets at the another communication apparatus, and a processor coupled to the memory and configured to determine a first transmission rate of the packets transmitted from the communication apparatus to the another communication apparatus, a receiving rate of the packets at the another communication apparatus being a maximum value without a packet loss when the communication apparatus transmits the packets at the first transmission rate, based on the relation information, select a packet loss rate among the plurality of packet loss rates, the throughput of the data corresponding to the selected packet loss rate being under a threshold, based on the first transmission rate and the selected packet loss rate, determine a second transmission rate higher than the first transmission rate, and transmit the packets from the communication apparatus to the another communication apparatus at the second transmission rate.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of how to measure a transmission rate;

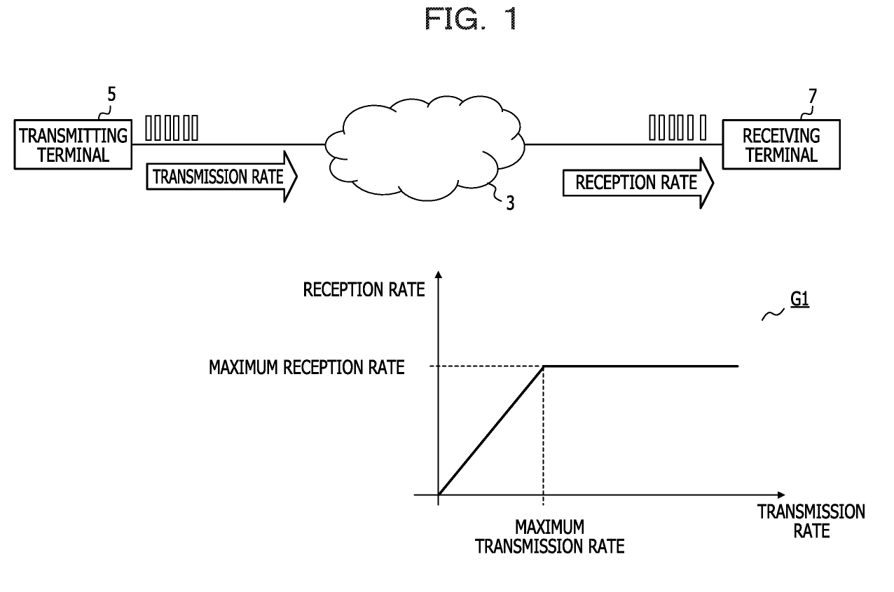

FIG. 2 is a diagram illustrating an example of protocols used for transmission and reception of data;

FIG. 3 is a diagram illustrating an example of a communication method according to an embodiment;

FIG. 4 is a diagram illustrating an example configuration of a communication apparatus;

FIG. 5 is a diagram illustrating an example hardware configuration of the communication apparatus;

FIG. 6 is a diagram illustrating an example of drop-rate characteristics in a transport protocol;

FIG. 7 is a diagram illustrating an example of a drop-rate characteristics table;

FIG. 8 is a flowchart illustrating an example of how to determine a performance-limit drop rate;

FIG. 9 is a diagram illustrating an example format of a packet;

FIG. 10 is a sequence diagram illustrating a communication method according to a first embodiment;

FIG. 11 is a flowchart illustrating an example of processing performed by a transmitting communication apparatus;

FIG. 12 is a flowchart illustrating an example of processing performed by a receiving communication apparatus;

FIG. 13 is a flowchart illustrating an example of processing performed by a transmitting communication apparatus;

FIG. 14 is a diagram illustrating an example configuration of a communication apparatus used in a third embodiment;

FIG. 15 is a diagram illustrating an example of a drop-rate characteristics table;

FIG. 16 is a sequence diagram illustrating a communication method according to the third embodiment;

FIG. 17 is a flowchart illustrating an example of processing performed by a transmitting communication apparatus;

FIG. 18 is a flowchart illustrating an example of processing performed by a receiving communication apparatus;

FIG. 19 is a diagram illustrating an example configuration of a communication apparatus used in a fourth embodiment; and

FIG. 20 is a sequence diagram illustrating a communication method according to the fourth embodiment.

### DESCRIPTION OF EMBODIMENTS

As discussed in BACKGROUND, the maximum transmission rate causing no packet loss is used in packet transmission, so that the transmission rate used for the communications may be set as high as possible. It is desirable that the communication speed be increased even more to enhance the communication efficiency. However, too high a transmission rate causes packets to be dropped and therefore decreases data throughput, leading to low communication efficiency as a result.

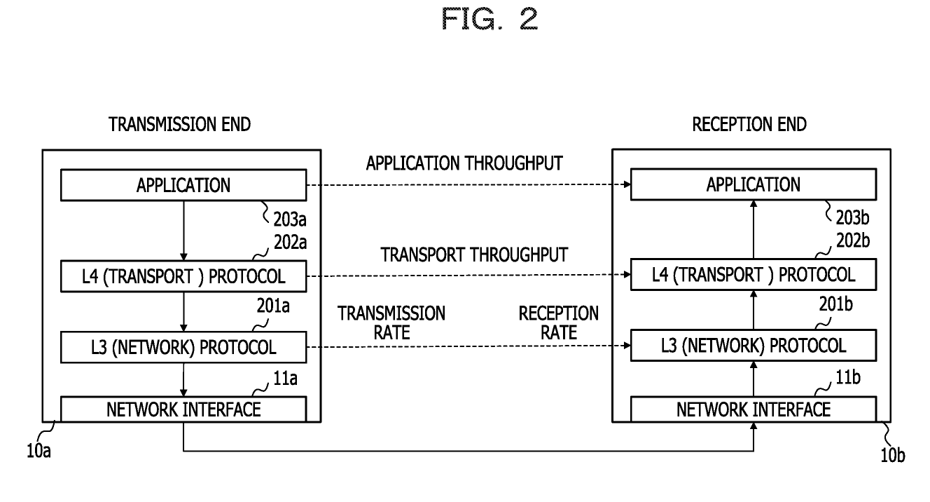

FIG. 2 is a diagram illustrating an example of protocols used in transmission and reception of data. In the example of FIG. 2, a communication apparatus 10a transmits packets to a communication apparatus 10b.

Data to be delivered to the communication apparatus 10b is generated by an application 203a in the communication apparatus 10a, and is included in packets for the communication apparatus 10b by being subjected to processing of an L4 (transport) protocol 202a and an L3 (network) protocol 201a. A network interface (a network interface card (NIC)) 11a transmits the packets for the communication apparatus 10b to the communication apparatus 10b.

The communication apparatus 10b receives the packets at a network interface 11b. The received packets are processed by an L3 (network) protocol 201b and an L4 (transport) protocol 202b, and data in the received packets are outputted to an application 203b. The application 203b performs appropriate processing using the received data.

The throughput of data sent from the application 203a to the application 203b is data throughput on the application layer (application throughput). Similarly, the throughput of data sent from the L4 (transport) protocol 202a to the L4 (transport) protocol 202b is data throughput on the transport layer (transport throughput).

Herein, a transmission rate refers to a rate at which the transmitting communication apparatus 10a transmits packets to the communication apparatus 10b, and a reception rate refers to a rate at which the communication apparatus 10b receives packets from the communication apparatus 10a. Until packet loss occurs, the transmission rate at the communication apparatus 10a and the reception rate at the communication apparatus 10b are the same value, but once packet loss occurs, the transmission rate at the communication apparatus 10a becomes higher than the reception rate at the communication apparatus 10b. Note that the transport throughput is smaller than the transmission rate because a packet includes a header such as an Internet Protocol (IP) header.

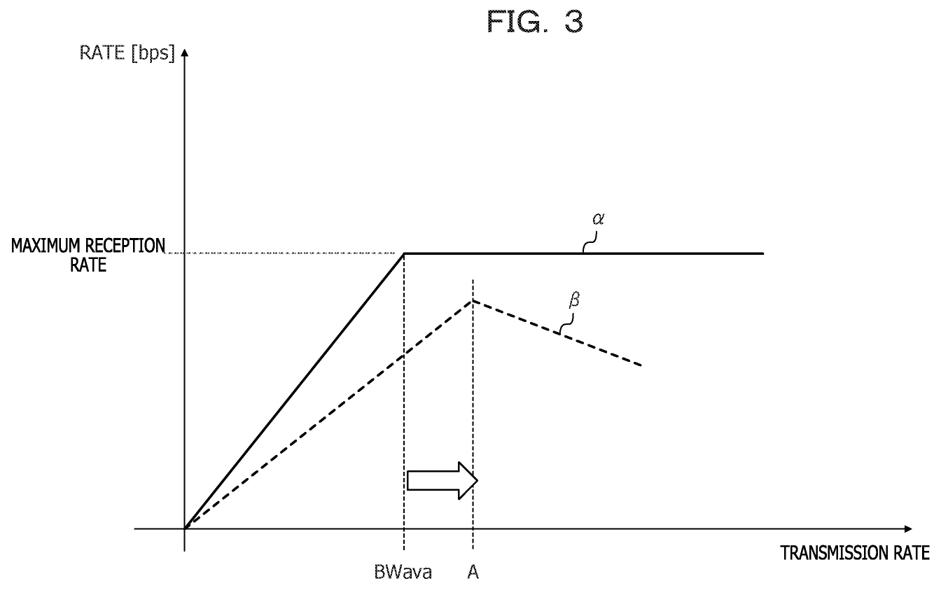

FIG. 3 is a diagram illustrating an example of a communication method according to an embodiment. In FIG. 3, α denotes the reception rate at a receiving apparatus obtained while the transmission rate of packets from a transmitting apparatus is changed. As described with reference to FIG. 2, the transmission rate and the reception rate both denote a forwarding rate on the network layer. Thus, the reception rate and the transmission rate are the same value until packet loss occurs: when the transmission rate is increased, the reception rate is increased according to the change in the transmission rate. In FIG. 3, the maximum value of a transmission rate usable without causing packet loss is denoted as BWava. In the following description, the maximum value of a transmission rate usable without causing packet loss may be referred to as a “maximum transmission rate”. The maximum value of a transmission rate usable without causing packet loss may also be referred to as an “available bandwidth”.

A graph denoted as β may be obtained by plotting the transport throughput at the receiving end obtained while the transmission rate of packets from the transmitting apparatus is changed. The graph denoted as β demonstrates that the transport throughput improves even if packet loss occurs, as long as an increase in the amount of arrived data by an increase in the transmission rate exceeds the amount of data that the receiving apparatus fails to receive due to packet loss. For example, if the transport protocol may perform error correction to restore data in a packet unreceived due to packet loss, there is actually no data that the receiving apparatus failed to acquire. For this reason, as long as data in an unreceived packet may be restored, the transport protocol throughput improves even if packet loss occurs. In FIG. 3, A denotes the transmission rate where the transport throughput is at its highest.

A communication apparatus 10 according to the embodiment finds the transmission rate where the transport throughput is at its highest, as represented with A in FIG. 3. To this end, the communication apparatus 10 uses information in which data throughput, which is obtained using a transport protocol for communicating with the communicating partner apparatus, is associated with a packet drop rate. The communication apparatus 10 uses the transmission rate where the transport throughput is at its highest to transmit packets to a communication-partner apparatus. Thus, more efficient communication is enabled when the communication apparatus of the embodiment is used.

For communications with a communication-partner apparatus, the communication apparatus 10 may use a transmission rate which is lower than or equal to the transmission rate where the transport throughput is at its highest and higher than the maximum value of the transmission rate causing no packet loss. Efficient communication is still enabled in this case because the communication-partner apparatus may receive more packets than it may receive under no packet loss, by the amount of data correctable by error correction.

Note that the transport throughput is almost the same value as the application throughput. For example, even when error correction is performed in the transport layer, data restored by the error correction is processed by the applications 203 as well; hence, the application throughput and the transport throughput are almost the same value. Thus, as described with reference to FIG. 3, efficient communication is enabled by using a transmission rate where data throughput on the transport layer is at its highest.

### First Embodiment

Descriptions are given below of (1) the configuration of the communication apparatus, (2) an example of how to find a transmission rate that maximizes the transport throughput, and (3) an example of communications between communication apparatuses.

(1) Configuration of the Communication Apparatus

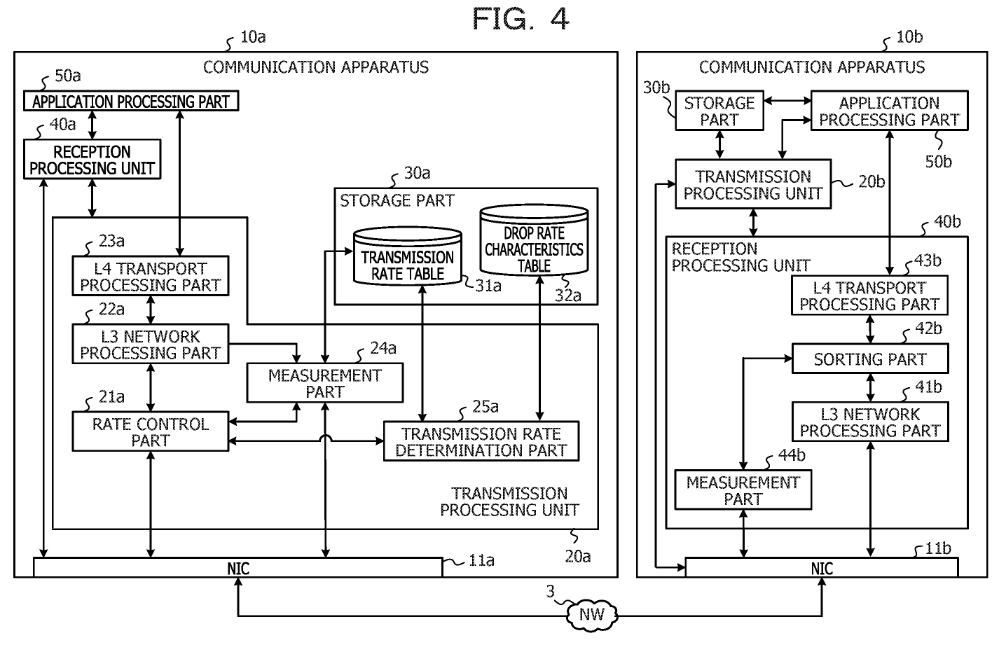

FIG. 4 is a diagram illustrating an example configuration of the communication apparatus 10. In the example illustrated in FIG. 4, the communication apparatus 10a transmits packets to the communication apparatus 10b via the network 3. In the following description, the reference numeral for an element may be followed by “a” if the element is in the communication apparatus 10a and “b” if the element is in the communication apparatus 10b to clarify which of the communication apparatuses 10a and 10b is performing an operation. The communication apparatus 10a and the communication apparatus 10b both include a network interface 11, a transmission processing unit 20, a storage part 30, a reception processing unit 40, and an application processing part 50.

Details of the transmission processing unit 20 and the storage part 30, which are used for packet transmission, are depicted within the communication apparatus 10a. The transmission processing unit 20 has a rate control part 21, an L3 network processing part 22, an L4 transport processing part 23, a measurement part 24, and a transmission rate determination part 25. The storage part 30 retains a transmission rate table 31 and a drop rate characteristics table 32.

The network interface 11 transmits and receives packets. The rate control part 21 controls a packet transmission rate at a value determined by the transmission rate determination part 25. The L3 network processing part 22 performs network layer processing on packets. The L4 transport processing part 23 performs transport layer processing on data in packets. The L4 transport processing part 23 performs transport header processing as appropriate. In addition, if a transport protocol employed performs error correction, the L4 transport processing part 23 includes, in transmitted data, redundant data used for the error correction. The measurement part 24 performs processing for finding the maximum value of a transmission rate usable without causing packet loss (BWava). The measurement part 24 stores the maximum value of a transmission rate usable without causing packet loss in the transmission rate table 31. The transmission rate determination part 25 determines a transmission rate that maximizes transport throughput, using the transmission rate table 31 and the drop rate characteristics table 32. The drop rate characteristics table 32 is information in which data throughput, which is obtained using a transport protocol for communicating with the communicating partner apparatus, is associated with a packet drop rate. An example of the drop rate characteristics table 32 will be described later.

Details of the reception processing unit 40, which is used for packet reception, are depicted within the communication apparatus 10b. The reception processing unit 40 has an L3 network processing part 41, a sorting part 42, an L4 transport processing part 43, and a measurement part 44.

The L3 network processing part 41 performs network layer processing on packets. The sorting part 42, based on the payload of a packet, outputs a transmission-rate-measurement packet to the measurement part 44 and outputs a data packet to the L4 transport processing part 43. The L4 transport processing part 43 performs processing according to the transport protocol and outputs data to the application processing part 50. The application processing part 50 processes data as appropriate. The measurement part 44, using measurement packets, calculates a reception rate of measurement packets and notifies the transmitter of the measurement packets of the reception rate thus obtained.

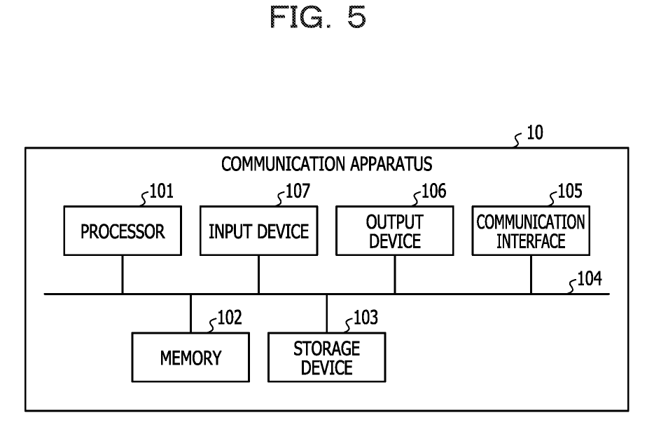

FIG. 5 is a diagram illustrating an example hardware configuration of the communication apparatus 10. The communication apparatus 10 has a processor 101, a memory 102, a storage device 103, a bus 104, and a communication interface 105, and optionally has an output device 106 and an input device 107. The processor 101 is any processing circuit, and may for example be a central processing unit (CPU). The processor 101 executes programs using the memory 102 as working memory and thereby executes various kinds of processing. The memory 102 includes a random-access memory (RAM) and non-volatile memory such as a read-only memory (ROM). The memory 102 and the storage device 103 are used to store programs and data for use in the processing performed by the processor 101. The communication interface 105 is used for communications with other apparatuses via a network. The bus 104 connects the processor 101, the memory 102, the storage device 103, and the communication interface 105 to one another to enable data input and output thereamong. The input device 107 is any device used to input information, such as a keyboard or a mouse, and the output device 106 is any device used for data output, such as a display device having a display.

In the communication apparatus 10, the processor 101 operates as the transmission processing unit 20, the reception processing unit 40, and the application processing part 50. The memory 102 and the storage device 103 operate as the storage part 30. The communication interface 105 operates as the network interface 11.

(2) Example of How to Find a Transmission Rate that Maximizes Transport Throughput

Taking an example where data is transmitted from the communication apparatus 10a to the communication apparatus 10b using a transport protocol that performs error correction, an example is described below of how the communication apparatus 10a determines a transmission rate that maximizes transport throughput.

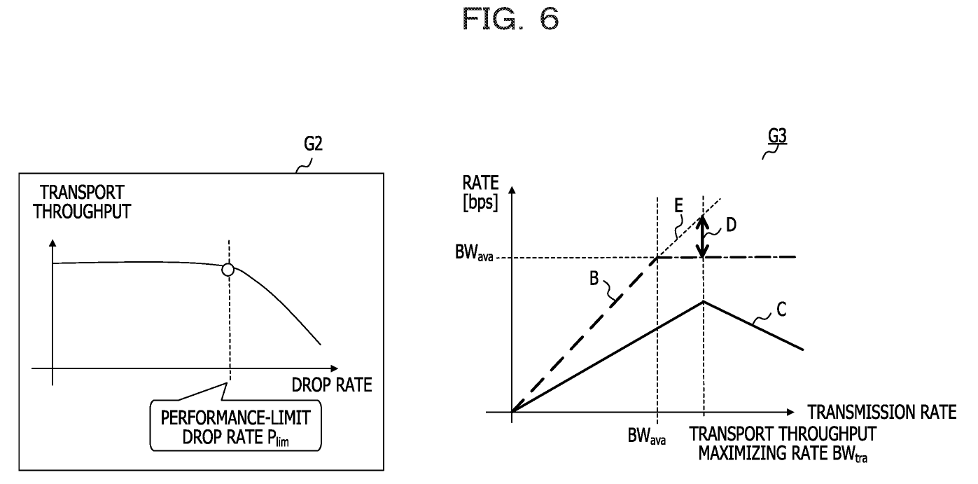

FIG. 6 is a diagram illustrating an example of drop rate characteristics of the transport protocol. Graph G2 in FIG. 6 is a graph of information in the drop rate characteristics table 32a retained by the communication apparatus 10a when a transport protocol that performs error correction is used. In graph G2, the vertical axis represents throughput, and the horizontal axis represents a drop rate. A drop rate X is a percentage of packet loss occurred, and is expressed by Formula (1):

X=(TR−RR)/TR (1)
where a variable TR is a transmission rate and a variable RR is a reception rate. Hereinbelow, the maximum value of a drop rate where data in an unreceived packet is restorable by error correction is referred to as a “performance-limit drop rate”.

The graph G2 represents how the transport throughput changes according to the drop rate with the transmission rate being maintained at a certain predetermine value. It is predictable from the graph G2 that even if packet loss occurs, the transport throughput does not decrease owing to error correction performed by the receiving communication apparatus 10b until the drop rate of data transmitted from the communication apparatus 10a reaches the performance-limit drop rate (Pₗᵢₘ). Once the drop rate exceeds Pₗᵢₘ, packet loss is not coverable by the error correction capability, and thus the transport throughput decreases. Thus, if the transmission rate is raised to a point where the drop rate is at Pₗᵢₘ, data in lost packets are reproduced by error correction, which enables maximization of the transport throughput.

G3 in FIG. 6 is a graph of a reception rate and transport throughput each plotted as a function of a transmission rate with the vertical axis being a rate. The reception rate is throughput at the network layer and is proportional to the number of packets successfully received by the receiving communication apparatus 10b. Thus, as B in graph G3 indicates, the reception rate increases as the transmission rate increases until packet loss occurs, and then stops changing once the transmission rate reaches BWava where packet loss starts to occur. Note that BWava is the maximum value of a transmission rate causing no packet loss. In graph G3, the transmission rate is the value on the horizontal axis, and therefore plotting the transmission rate forms a straight line with a gradient of 1, as indicated by E in graph G3. Thus, the difference between the thin dotted line E and the thick broken line B, which represents the reception rate, is the amount of packets not received due to packet loss.

The transport throughput, on the other hand, increases as the transmission rate increases even after packet loss occurs, as C in graph G3 indicates, while data in unreceived packets are reproduced by error correction. Thus, even after the transmission rate reaches BWava, the transport throughput improves until the percentage of packet loss occurrence reaches the performance-limit drop rate Pₗᵢₘ. A forwarding rate where the percentage of packet loss occurrence is equal to the performance-limit drop rate is referred to as a transport-throughput maximizing rate (BWtra). Then, as C in graph G3 indicates, the transport throughput is at its maximum value when the transmission rate reaches the transport-throughput maximizing rate BWtra, and then lowers when the transmission rate increases further. This represents that when packets are transmitted at the transport-throughput maximizing rate, packets are dropped in the amount indicated by D in graph G3.

The transport throughput maximizing rate BWtra is a transmission rate that maximizes the transport throughput; thus, a transmission rate when drop rate=Pₗᵢₘ is BWtra. Since transmission rate=BWtra≧BWava, a reception rate when drop rate=Pₗᵢₘ is BWava. Thus, the following Formula (2) holds true:

Pₗᵢₘ=(BWtra−BWava)/BWtra. (2)

BWtra may be expressed as the following Formula (3) by rearranging Formula (2):

BWtra=BWava/(1−Pₗᵢₘ). (3)

Thus, the transmission rate determination part 25a in the communication apparatus 10a, which performs transmission processing, may use Formula (3) to calculate a transmission rate BWtra that maximizes transport throughput, based on the performance-limit drop rate and the maximum value BWava of a transmission rate causing no packet loss.

Any known method may be employed to find the maximum value BWava of a transmission rate causing no packet loss. The performance-limit drop rate may be found using the drop rate characteristics table 32 and the like.

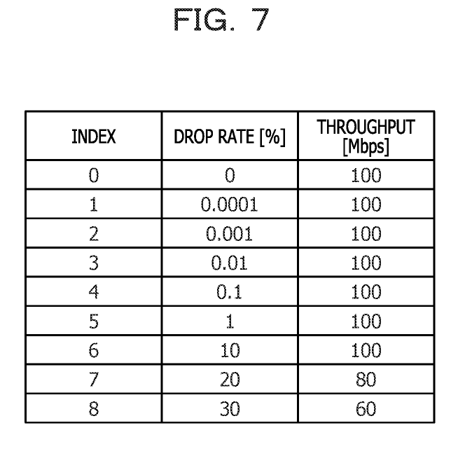

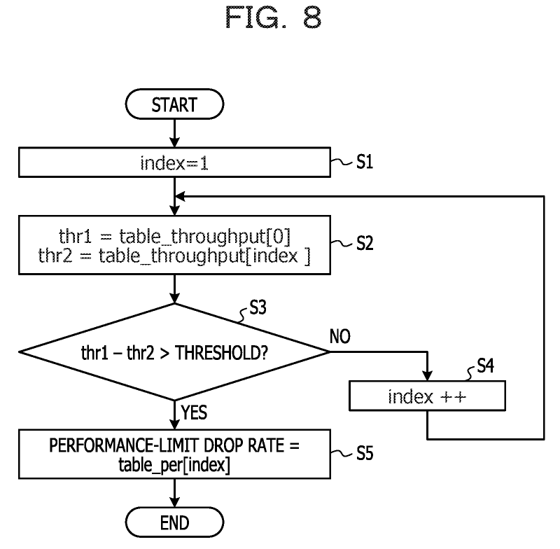

FIG. 7 is a diagram illustrating an example of the drop rate characteristics table 32. The drop rate characteristics table 32 illustrated in FIG. 7 includes an index, a drop rate, and throughput associated with one another. The drop rate and throughput are generated based for example on simulation results obtained by a model system for evaluating the characteristics of the transport protocol using the transport protocol used for communications. The simulation results are values of transport protocol plotted as a graph as a function of the drop rate, like the graph G2 plotted in FIG. 6, and the drop rate characteristics table 32 is generated by sampling of the simulation results. An index is associated with a combination of a drop rate and throughput. In the example depicted in FIG. 7, while the drop rate is from 0% to 10%, data in unreceived packets are reproduced by error correction of the transport protocol. Note that FIG. 7 is merely an example, and for instance, the sampling interval for the drop rate-throughput combinations is not restrictive. With reference to FIG. 8, a description is now given of how to find the performance-limit drop rate using the drop rate characteristics table 32 depicted in FIG. 7.

FIG. 8 is a flowchart illustrating an example of processing for determining a performance-limit drop rate. The transmission rate determination part 25 sets a variable “index” to 1 (Step 51). The transmission rate determination part 25 sets a variable thr1 to the throughput in the drop rate characteristics table 32 associated with index=0, and a variable thr2 to the throughput in the drop rate characteristics table 32 associated with the same index as the variable “index” (Step S2). The transmission rate determination part 25 determines whether a value obtained by subtraction of the variable thr2 from the variable thr1 exceeds a threshold (Step S3). If the value obtained by subtraction of the variable thr2 from the variable thr1 does not exceed the threshold (No in Step S3), the transmission rate determination part 25 increments the variable “index” and proceeds back to Step S2 (Step S4). If, on the other hand, the value obtained by subtraction of the variable thr2 from the variable thr1 exceeds the threshold (Yes in Step S3), the transmission rate determination part 25 determines that the rate drop in the combination associated with the same index value as the variable “index” is the performance-limit drop rate (Step S5).

For instance, assume that the threshold used in Step S3 is set to 10% of the throughput associated with index=0. In this case, assuming that the drop rate characteristics table 32 looks like the one in FIG. 7, when index=7, thr1=100 Mbps and thr2=80 Mbps. Then, a value obtained by subtraction of the variable thr2 from the variable thr1 is 100 Mbps−80 Mbps=20 Mbps, which exceeds the threshold, which is (100 Mbps×10%=) 10 Mbps. Then, the transmission rate determination part 25 determines that 10%, which is the drop rate associated with index=6, is the performance-limit drop rate. Then, using the performance-limit drop rate Pₗᵢₘ and the transmission rate BWava causing no packet loss in Formula (3), the transmission rate determination part 25 calculates the transmission rate BWtra that maximizes the transport throughput.

(3) Example of Communications between the Communication Apparatuses 10

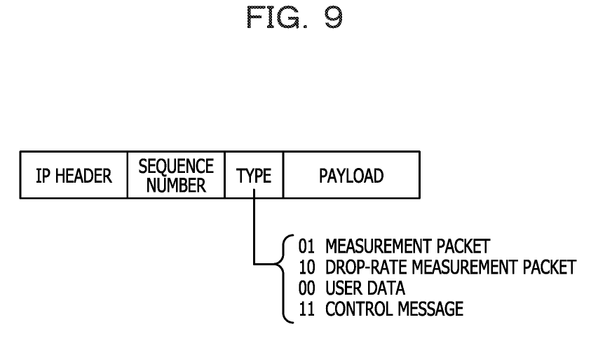

FIG. 9 is a diagram illustrating an example of the format of a packet used for communications. A packet includes an Internet Protocol (IP) header, a sequence number, type information, and payload. The payload includes a header used by the transport protocol, and the like. A sequence number is a value used for measurement of a drop rate and a transmission rate, and is set by the L3 network processing part 22 of the transmitting communication apparatus 10. The type information is two-bit long and represents the type of the packet. In the example in FIG. 9, the type information indicates the type of a packet as follows. When the type information is “01”, the packet is a measurement packet used for measurement of the maximum value of a transmission rate (BWava). When the type information is “10”, the packet is used for measurement of a drop rate (drop-rate measurement packet). The drop-rate measurement packet is used when the communication apparatus 10 does not have the drop rate characteristics table 32. Processing that uses the drop-rate measurement packet will be described later. When the type information is “00”, the packet is used for transmission and reception of user data. When the type information is “11”, the packet is used for transmission and reception of a control message.

The sorting part 42 of the receiving communication apparatus 10b performs the packet sorting processing by using the type information. Processing performed by the sorting part 42 will be described later.

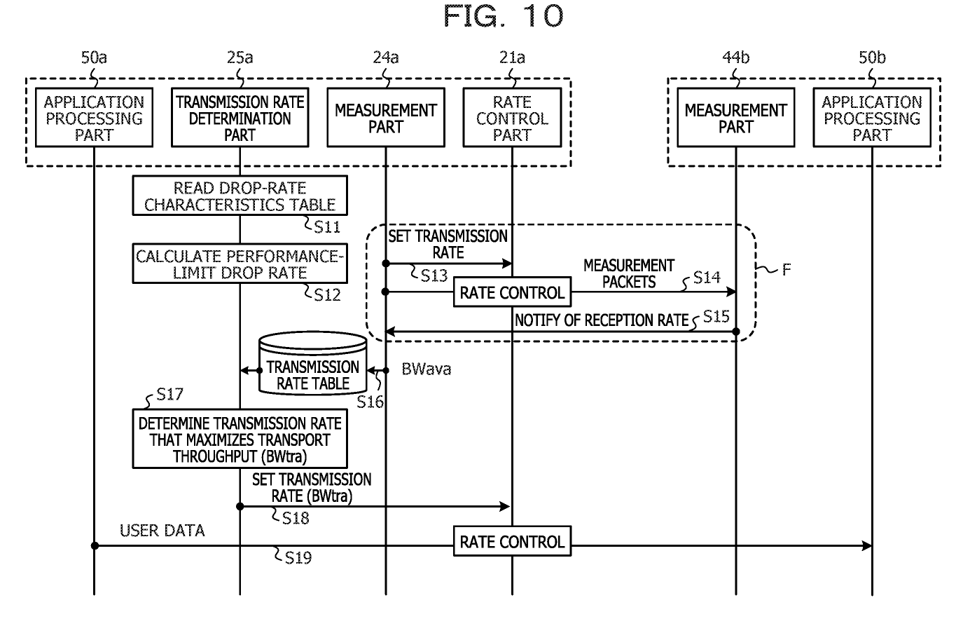

FIG. 10 is a sequence diagram illustrating a communication method according to the first embodiment. The transmission rate determination part 25a in the communication apparatus 10a reads the drop rate characteristics table 32a (Step S11) and calculates a performance-limit drop rate (Step S12). The processing in Step S12 is the same as the processing described using FIGS. 7 and 8.

Next, the maximum value BWava of a transmission rate causing no packet loss is measured. Processing for measuring the maximum value BWava of a transmission rate causing no packet loss is the processing depicted within a dotted line denoted as F.

In Step S13, the measurement part 24a sets, in the rate control part 21a, a transmission rate to use for communications with the communication apparatus 10b to which to transmit packets. To the L3 network processing part 22a, the measurement part 24a outputs payload to be included in measurement packets and information indicating that the communication apparatus 10b is the destination of the measurement packets. The L3 network processing part 22a generates measurement packets by adding type information “01” used for the identification of the measurement packets and sequence numbers to the payload to be included in the measurement packets and then adding an IP header to the payload. The L3 network processing part 22a outputs the generated measurement packets to the rate control part 21a. The rate control part 21a transmits the packets inputted from the L3 network processing part 22a to the communication apparatus 10b at the transmission rate set by the measurement part 24a (Step S14).

The network interface 11b of the communication apparatus 10b outputs the measurement packets to the L3 network processing part 41b. The L3 network processing part 41b processes the IP header in the measurement packets and outputs information following the IP header to the sorting part 42b. When determining that the packets are measurement packets based on the type information, the sorting part 42b outputs the measurement packets to the measurement part 44b. The measurement part 44b measures a reception rate of the measurement packets and transmits the measured reception rate to the communication apparatus 10a via the network interface 11b (Step S15). A control packet with the type information “11” may be used for the notification of the reception rate.

Via the network interface 11a, the L3 network processing part 41a of the communication apparatus 10a receives the control packet notifying of the reception rate. The L3 network processing part 41a processes the IP header of the control packet notifying of the reception rate and outputs the data in the control packet to the sorting part 42a. Based on the type information and the like, the sorting part 42a outputs the information thus obtained to the measurement part 24a. The measurement part 24a determines based on the information thus obtained whether the transmission rate is equal to the reception rate. If the transmission rate does not exceed the reception rate, the measurement part 24a sets a higher transmission rate in the rate control part 21a and repeats Steps S13 to S15 in order to find the maximum value of a transmission rate equaling the reception rate. Also when the transmission rate is equal to the reception rate, the measurement part 24a sets a higher transmission rate in the rate control part 21a and repeats Steps S13 to S15 to find the maximum value of a transmission rate equaling the reception rate. The maximum value of a transmission rate equaling the reception rate is the maximum value BWava of a transmission rate causing no packet loss.

Although Steps S13 to S15 in F are performed only once in FIG. 10 for easy visibility of the drawing, the processing in F in FIG. 10 is repeated while changing the value set in Step S13 until the transmission rate BWava is found.

The measurement part 24a records the obtained transmission rate BWava in the transmission rate table 31a (Step S16). Then, the transmission rate determination part 25a may acquire the transmission rate BWava by accessing the transmission rate table 31a.

Using the transmission rate BWava and the performance-limit drop rate Pₗᵢₘ found in Step S12 in the following formula, the transmission rate determination part 25a determines a transmission rate BWtra that maximizes the transport throughput (Step S17):

BWtra=BWava/(1−Pₗᵢₘ).

The transmission rate determination part 25a sets the transmission rate BWtra in the rate control part 21a as a transmission rate for packets containing user data (Step S18).

Assume that data for the communication apparatus 10b is generated in Step S19 by processing performed by the application processing part 50a. The application processing part 50a outputs the generated data to the L4 transport processing part 23a along with information indicating that the destination is the communication apparatus 10b. The L4 transport processing part 23a performs transport layer processing on the data and outputs the processed data to the L3 network processing part 22a. The L3 network processing part 22a generates transmission packets by appropriately including a sequence number and type information indicative of user data (type information=“00”) in the inputted data and then adding an IP header to the data. The L3 network processing part 22a outputs the generated packets to the rate control part 21a. The rate control part 21a transmits the packets to the communication apparatus 10b via the network interface 11a while controlling the transmission rate at BWtra, which is the value designated by the transmission rate determination part 25a. In this way, packets containing user data are transmitted to the communication apparatus 10b at the transmission rate BWtra. Thus, a certain percentage of packets transmitted from the communication apparatus 10a to the communication apparatus 10b do not arrive at the communication apparatus 10b due to packet loss, the percentage being the performance-limit drop rate Pₗᵢₘ.

Upon receipt of packets via the network interface 11b, the L3 network processing part 41b of the communication apparatus 10b outputs data in the packets to the sorting part 42b. Since the value of the type information in the data inputted indicates user data, the sorting part 42b outputs the inputted data to the L4 transport processing part 43b. The L4 transport processing part 43b performs processing according to the transport protocol. Error correction is performed according to the transport protocol used in the L4 transport processing part 43b, and data in the lost packets are reproduced. The L4 transport processing part 43b outputs the error-corrected data to the application processing part 50b.

Note that the processing depicted in FIG. 10 is merely an example, and the order of steps may be changed according to the implementation. For example, Steps S13 to S15 may be performed before or in parallel with Steps S11 to S12.

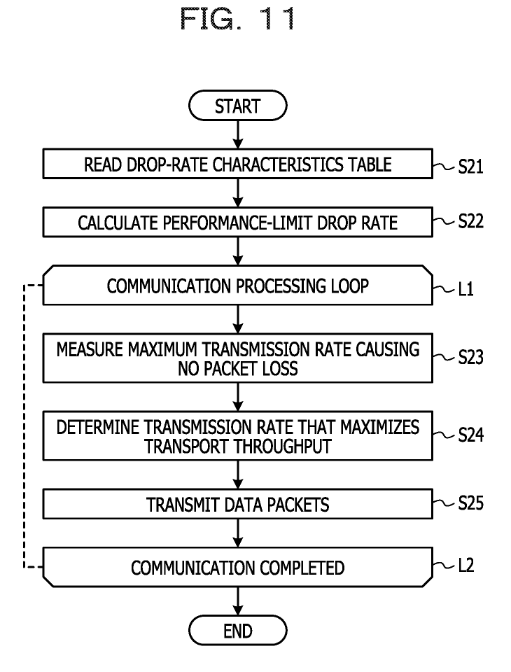

FIG. 11 is a flowchart illustrating an example of processing performed by the transmitting communication apparatus 10. The transmission rate determination part 25 reads the drop rate characteristics table 32 (Step S21) and calculates a performance-limit drop rate Pₗᵢₘ (Step S22). The performance-limit drop rate Pₗᵢₘ is calculated in the same manner described with reference to FIGS. 7 and 8. Next, the communication apparatus 10 performs a communication processing loop which starts at a loop end L1 and ends at a loop end L2. The measurement part 24 measures the maximum transmission rate BWava causing no packet loss (Step S23). Step S23 is performed in the same manner as Steps S13 to S15 in FIG. 10. Using the performance-limit drop rate Pₗᵢₘ and the transmission rate BWava, the transmission rate determination part 25 determines a transmission rate BWtra that maximizes the transport throughput (Step S24). The transmission rate determination part 25 sets the determined transmission rate BWtra in the rate control part 21. Thereafter, the rate control part 21 transmits data packets at the transmission rate BWtra that maximizes the transport throughput (Step S25). Steps S23 to S25 are iterated until the communication is completed. Once the communication is completed, the communication apparatus 10 leaves the communication processing loop and ends the processing.

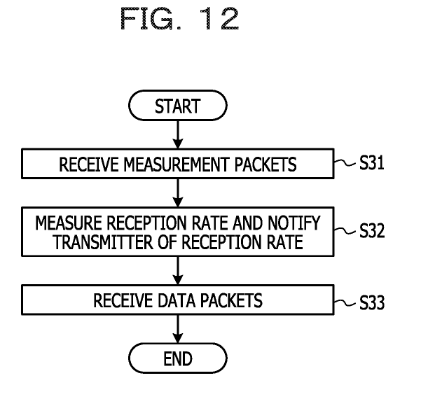

FIG. 12 is a flowchart illustrating an example of processing performed by the receiving communication apparatus 10. The network interface 11 receives measurement packets (Step S31). The measurement packets are outputted to the measurement part 44 via the L3 network processing part 41 and the sorting part 42. The measurement part 44 measures the reception rate of the measurement packets and notifies the transmitter of the measurement packets of the reception rate (Step S32). Thereafter, the receiving communication apparatus 10 receives data packets (Step S33). Packet loss occurs since the data packets are transmitted to the receiving communication apparatus 10 at the transmission rate BWtra that maximizes the transport throughput, which is determined by the transmitting communication apparatus 10. Thus, the L4 transport processing part 43 of the communication apparatus 10 performs error correction appropriately to reproduce data in the unreceived packets, and outputs the data to the application processing part 50.

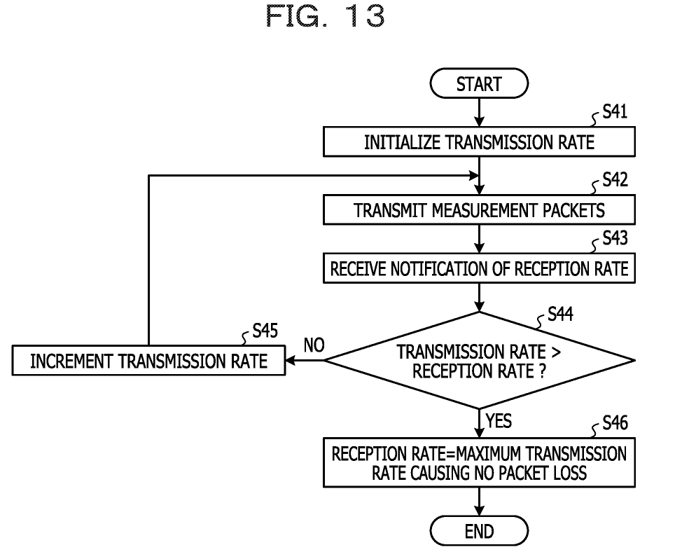

FIG. 13 is a flowchart illustrating an example of processing performed by the transmitting communication apparatus 10 when measuring the maximum value BWava of a transmission rate causing no packet loss. FIG. 13 illustrates an example of details of Step S23 in FIG. 11 and the processing F in FIG. 10.

The measurement part 24 initializes the transmission rate set in the rate control part 21 (Step S41). The measurement part 24 then transmits measurement packets to the communication partner via the rate control part 21 and the like (Step S42). In Step S42, the measurement packets are transmitted to the communication partner at the transmission rate set in the rate control part 21 since they are transmitted via the rate control part 21.

The network interface 11 receives a control packet from the receiver of the measurement packets, the control packet notifying of a reception rate (Step S43). The control packet is processed by the reception processing unit 40, and the notified reception rate is outputted to the measurement part 24 as a result. The measurement part 24 determines whether the transmission rate exceeds the reception rate (Step S44). If the transmission rate does not exceed the reception rate (No in Step S44), the measurement part 24 increments the transmission rate and proceeds back to Step S42 (Step S45). In this event, the measurement part 24 changes the transmission rate set in the rate control part 21, as well. Steps S42 to S45 are iterated until the transmission rate exceeds the reception rate.

If the transmission rate exceeds the reception rate (Yes in Step S44), the measurement part 24 determines that the obtained reception rate is the maximum transmission rate causing no packet loss (BWava) (Step S46).

In this way, the communication apparatus 10 transmits packets to the communication partner at the transmission rate determined so as to maximize the transport throughput. Using the communication method according to the first embodiment therefore enables more efficient communication.

For instance, assume a case where the maximum transmission rate causing no packet loss (BWava) between the communication apparatus 10a and the communication apparatus 10b is 100 Mbps and the performance-limit drop rate Pₗᵢₘ is 10% for the protocol used between the communication apparatus 10a and the communication apparatus 10b. In this case, the transmission rate determination part 25 finds the transmission rate BWtra that maximizes the transport throughput by following the calculation below:

BWtra=BWava/(1−Plim)=100/(1−0.1)=111.

Thus, although the maximum transmission rate causing no packet loss (BWava) is 100 Mbps, the communication apparatus 10a may transmit data packets to the communication apparatus 10b at 111 Mbps. Packet loss occurs because the data packets are transmitted at 111 Mbps, but data in packets that the communication apparatus 10b failed to receive are restored by error correction performed by the L4 transport processing part 43b. Thus, the communication apparatus 10b may efficiently receive data transmitted from the communication apparatus 10a.

### Second Embodiment

In the example described as the first embodiment, the communication apparatus 10 has the drop rate characteristics table 32 depicted in FIG. 7. Instead of the drop rate characteristics table 32, formulae or the like determined based on the protocol characteristics may be stored in the communication apparatus 10.

For instance, assume the following case. In the transport protocol used for communications between the communication apparatus 10a and the communication apparatus 10b, the transport throughput (Tthr) is expressed by Formula (4) below when drop rate≦10%:

Tthr=100. (4)

Similarly, when 10%<drop rate<50%, the relation between the drop rate P and the transport throughput (Tthr) is expressed by Formula (5):

Tthr=120−200×P. (5)

When drop rate≧50%, the transport throughput (Tthr) is expressed by Formula (6):

Tthr=20. (6)

The transmission rate determination part 25 of the transmitting communication apparatus 10a calculates transport throughput for each drop rate using these functions, and thereby generates a drop rate characteristics table 32a like the one illustrated in FIG. 7. Using the drop rate characteristics table 32a, the transmission rate determination part 25a calculates the performance-limit drop rate Pₗᵢₘ through the same processing described with reference to FIG. 8 and the like. Processing performed after the calculation of the performance-limit drop rate Pₗᵢₘ is the same as that in the first embodiment. Thus, as in the first embodiment, communication is performed at the transmission rate BWtra determined by the transmitting communication apparatus 10a so as to maximize the transport throughput, enabling efficient communication in the second embodiment as well.

In the second embodiment, the communication apparatus 10 only has to store, instead of the drop rate characteristics table 32, functions that describe the relations between the drop rate and the transport throughput in the transport protocol. This allows the communication apparatus 10 to have less memory capacity for data storage than that in the first embodiment.

### Third Embodiment

In a third embodiment, a description is given of an example case where a communication apparatus generates the drop rate characteristics table 32.

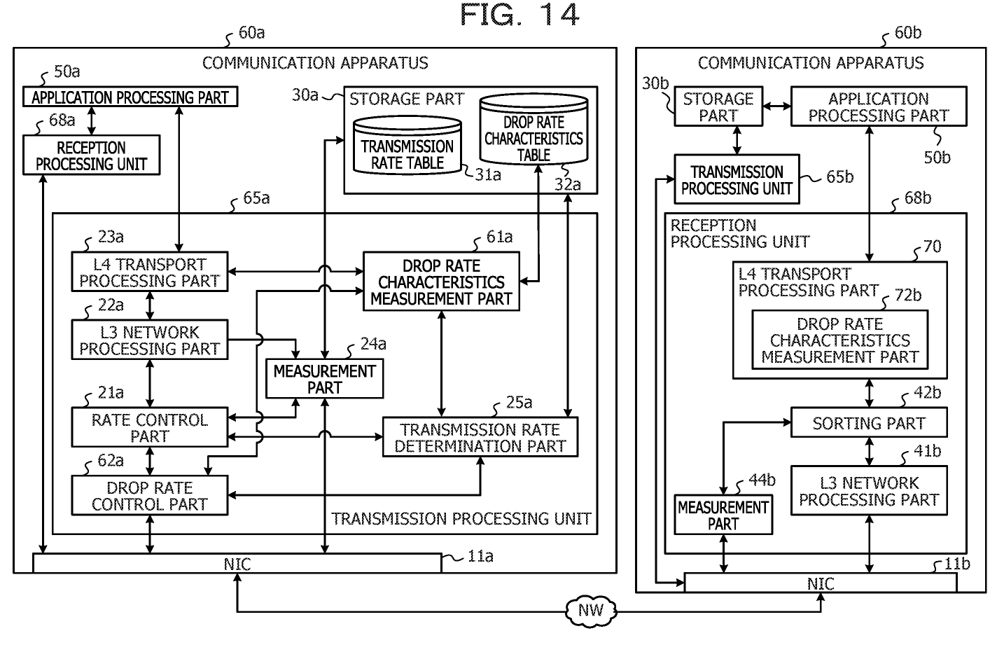

FIG. 14 is a diagram illustrating an example configuration of a communication apparatus 60 used in the third embodiment. The communication apparatus 60 includes a transmission processing part 65, a reception processing part 68, the application processing part 50, the storage part 30, and the network interface 11. In FIG. 14, details of the transmission processing part 65 are depicted within the communication apparatus 60a, and details of the reception processing part 68 are depicted within the communication apparatus 60b. The transmission processing part 65 and the reception processing part 68 are implemented by the processor 101.

The transmission processing part 65 has a drop rate characteristics measurement part 61 and a drop rate control part 62, and further has the rate control part 21, the L3 network processing part 22, the L4 transport processing part 23, the measurement part 24, and the transmission rate determination part 25. The reception processing part 68 has an L4 transport processing part 70, the L3 network processing part 41, the sorting part 42, and the measurement part 44. The L4 transport processing part 70 has a drop rate characteristics measurement part 72.

To generate the drop rate characteristics table 32, the drop rate characteristics measurement part 61 outputs, to the L4 transport processing part 23, data to be included in drop-rate measurement packets and information such as the number of the transmitted drop-rate measurement packets. The L4 transport processing part 23 and the L3 network processing part 22 process information inputted from the drop rate characteristics measurement part 61 and thereby generate drop-rate measurement packets and a control packet that includes the number of drop-rate measurement packets to be transmitted.

The drop rate control part 62 transmits the drop-rate measurement packets inputted from the rate control part 21 to the destination of the drop-rate measurement packets via the network interface 11. The drop rate control part 62 drops part of the drop-rate measurement packets inputted from the rate control part 21 so that the drop rate of the drop-rate measurement packets may be equal to the drop rate set by the transmission rate determination part 25.

The drop rate characteristics measurement part 72 measures the transport throughput of data received using the drop-rate measurement packets. The drop rate characteristics measurement part 72 calculates the drop rate of the drop-rate measurement packets, and associates the drop rate with the measured transport throughput. The drop rate characteristics measurement part 72 then performs processing for notifying the transmitter of the drop-rate measurement packets of a combination of the obtained drop rate and the transport throughput.

The application processing part 50, the rate control part 21, the L3 network processing part 22, the L4 transport processing part 23, the measurement part 24, the transmission rate determination part 25, the L3 network processing part 41, the sorting part 42, and the measurement part 44 perform the same processing as those in the first embodiment. The storage part 30 retains the transmission rate table 31 and the drop rate characteristics table 32. In the third embodiment, the communication apparatus 60 may update the drop rate characteristics table 32.

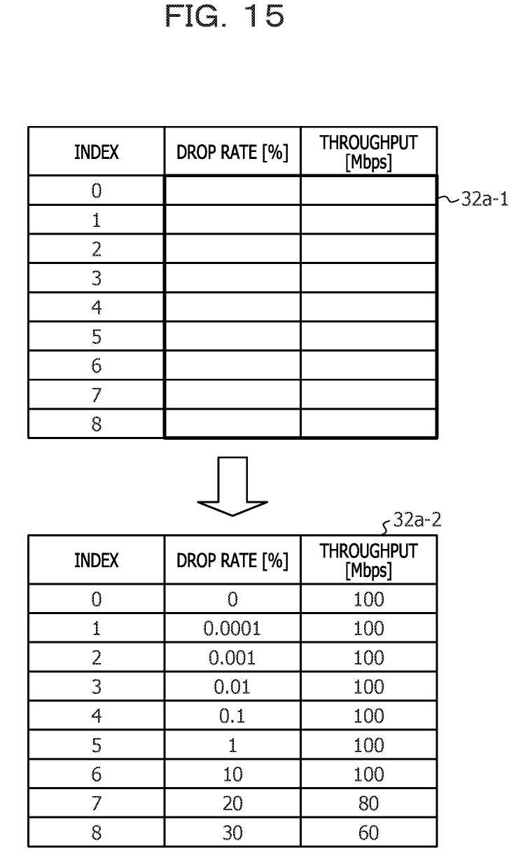

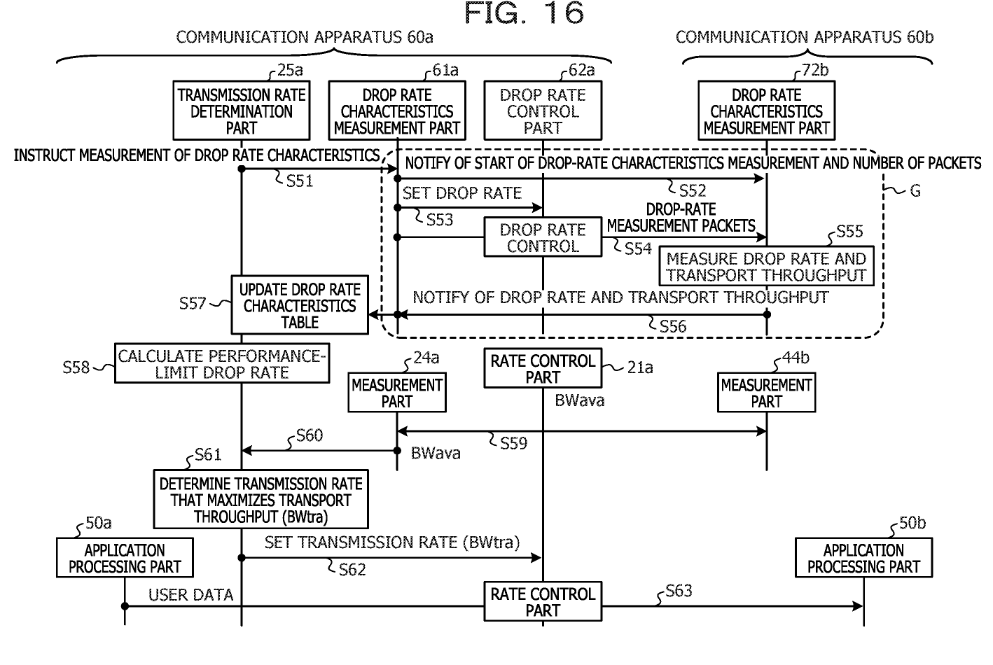

FIG. 15 is a diagram illustrating an example of the drop rate characteristics table 32. Before the drop rate characteristics according to the transport protocol used for communication are found, a drop rate characteristics table 32a-1 does not contain any correspondences between a drop rate and transport throughput. When starting communication with the communication apparatus 60b, the communication apparatus 60a transmits drop-rate measurement packets to the communication apparatus 60b through processing performed by the drop rate characteristics measurement part 61a, the drop rate control part 62a, and the like. When the drop rate characteristics measurement part 72b notifies the communication apparatus 60a of information obtained by processing performed by the L4 transport processing part 70b of the communication apparatus 60b, the drop rate characteristics measurement part 61a of the communication apparatus 60a records the obtained information in the drop rate characteristics table 32a. Thus, the drop rate characteristics table 32a-1 is updated to, for instance, a drop rate characteristics table 32a-2. With reference to FIG. 16, details of the processing for updating the drop rate characteristics table 32 are described below.

FIG. 16 is a sequence diagram illustrating a communication method according to the third embodiment. The following describes an example where the communication apparatus 60a transmits packets to the communication apparatus 60b. The transmission rate determination part 25a instructs the drop rate characteristics measurement part 61a to measure drop-rate characteristics (Step S51). In Step S51, the transmission rate determination part 25a notifies the drop rate characteristics measurement part 61a that the communication apparatus 60b is the communication partner in the measurement of the drop-rate characteristics.

In Step S52, the drop rate characteristics measurement part 61a determines the number of drop-rate measurement packets to transmit to the communication apparatus 60a in one measurement. The drop rate characteristics measurement part 61a determines this according to the drop rate set in the drop rate control part 62a. If, for instance, the drop rate set in the drop rate control part 62a is 0.0001%, one out of 1,000,000 packets is dropped. Thus, the drop rate control part 62a sets the number of drop-rate measurement packets to transmit in one measurement to a value not smaller than 1,000,000 packets, such as 100,000,000 packets. If the drop rate set in the drop rate control part 62a is 0%, the number of drop-rate measurement packets to transmit may be on the order of 10,000 packets. The drop rate characteristics measurement part 61a generates data to be included in a control packet for notifying the number of drop-rate measurement packets and outputs the data to the L4 transport processing part 23a. Using the data generated by the drop rate characteristics measurement part 61a, the L4 transport processing part 23a and the L3 network processing part 22a generate a control packet including a notification of starting the drop-rate characteristics measurement and the number of packets to be used for the measurement. The control packet is transmitted to the communication apparatus 60b via the network interface 11a.

The sorting part 42b of the communication apparatus 60b acquires the data in the control packet via the network interface 11b and the L3 network processing part 41b, and then outputs the data in the control packet to the drop rate characteristics measurement part 72b. The drop rate characteristics measurement part 72b stores the number of packets notified of through the control packet.

Meanwhile, in the communication apparatus 60a, the drop rate characteristics measurement part 61a sets a drop rate in the drop rate control part 62a (Step S53). In Step S54, the drop rate characteristics measurement part 61a outputs data to be included in drop-rate measurement packets to the L4 transport processing part 23a. By processing the data outputted from the drop rate characteristics measurement part 61a, the L4 transport processing part 23a and the L3 network processing part 22a generate drop-rate measurement packets. Assume that the L3 network processing part 22a sets the type information in the drop-rate measurement packets to “10” (see FIG. 9). The drop-rate measurement packets are outputted to the drop rate control part 62a via the L3 network processing part 22a and the rate control part 21a. The drop rate control part 62a drops part of the inputted drop-rate measurement packets so that the drop rate of the drop-rate measurement packets will be equal to the drop rate set by the drop rate characteristics measurement part 61a and transmits the rest of the drop-rate measurement packets to the communication apparatus 60b.

In the communication apparatus 60b, the sorting part 42b acquires the data in the drop-rate measurement packets via the network interface 11b. Since the type information set for the acquired data is “10”, the sorting part 42b outputs the acquired data to the drop rate characteristics measurement part 72b. The drop rate characteristics measurement part 72b measures transport throughput using data included in the payload of the drop-rate measurement packets. The drop rate characteristics measurement part 72b then calculates a drop rate using the sequence numbers in the drop-rate measurement packets and the number of packets notified of beforehand (Step S55). The drop rate characteristics measurement part 72b performs processing for transmitting a combination of the obtained drop rate and transport throughput to the communication apparatus 60a, which is the transmitter of the drop-rate measurement packets (Step S56).

The reception processing part 68a of the communication apparatus 60a acquires a notification of the combination of the drop rate and the throughput via the network interface 11a. The sorting part 42a in the reception processing part 68a outputs information in the acquired notification to the drop rate characteristics measurement part 61a. The drop rate characteristics measurement part 61a then stores the combination of the drop rate and the transport throughput in the drop rate characteristics table 32a, thereby updating the drop rate characteristics table 32a. Then, the drop rate characteristics measurement part 61a determines whether a combination of a drop rate and transport throughput is stored for every index in the drop rate characteristics table 32. The drop rate characteristics measurement part 61a iterates Steps S52 to S56 until a combination of a drop rate and transport throughput is stored for every index.

Although the processing denoted by G in FIG. 16, namely Steps S52 to S56, are performed only once in FIG. 16 for easy visibility of the drawing, the processing denoted by G in FIG. 16 is performed multiple times to generate the drop rate characteristics table 32. In other words, the processing denoted by G in FIG. 16 is iterated while changing the drop rate set in Step S53, until a combination of a drop rate and transport throughput is obtained for every index in the drop rate characteristics table 32. Note that the transmission rate is kept at a fixed value in every iteration of Steps S52 to S56 for updating the drop rate characteristics table 32.

Steps S58 to S63 are the same as Steps S12 to S19 in FIG. 10. The communication apparatus 60 according to the third embodiment may thus update information in the drop rate characteristics table 32.

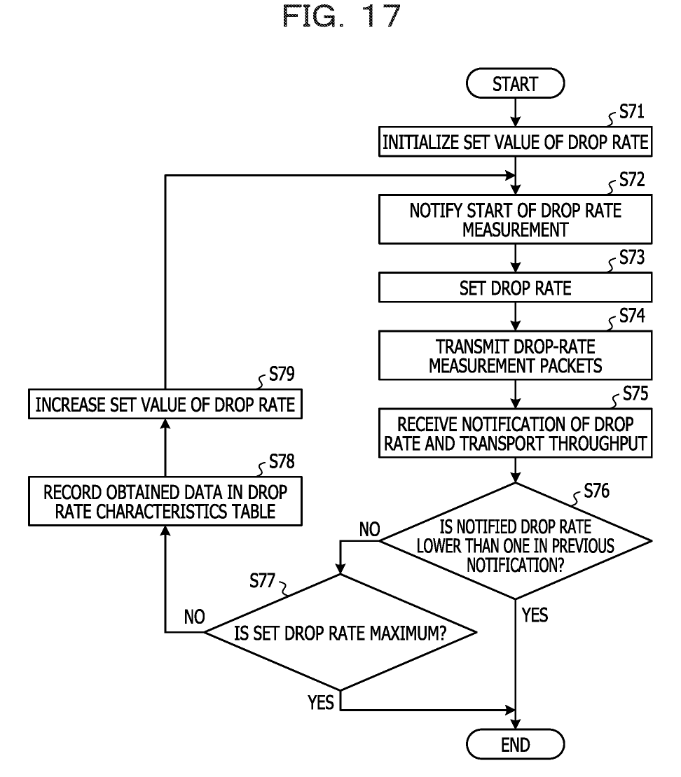

FIG. 17 is a flowchart illustrating an example of processing performed by the transmitting communication apparatus 60. The drop rate characteristics measurement part 61 initializes the drop rate set in the drop rate control part 62 (Step S71). The drop rate characteristics measurement part 61 performs processing for transmitting a notification of starting drop-rate measurement to the communication partner of the measurement of the drop rate (Step S72). The notification of starting drop rate measurement contains information on the number of drop-rate measurement packets to be transmitted in one drop-rate measurement. The drop rate characteristics measurement part 61 then sets a drop rate in the drop rate control part 62 (Step S73). After acquiring data to be included in drop-rate measurement packets from the drop rate characteristics measurement part 61, the L4 transport processing part 23 and the L3 network processing part 22 generate drop-rate measurement packets. The drop rate control part 62 drops part of the generated drop-rate measurement packets so that the drop rate of the drop-rate measurement packets will be equal to the drop rate set in Step S73, and transmits the undropped drop-rate measurement packets to the communication partner (Step S74).

Thereafter, the drop rate characteristics measurement part 61 acquires a notification of a drop rate and transport throughput at the communication-partner communication apparatus 60 via the network interface 11 and the reception processing part 68 (Step S75). The drop rate characteristics measurement part 61 determines whether the notified drop rate is lower than that in the previous notification (Step S76). The drop rate characteristics measurement part 61 ends the processing if the notified drop rate is lower than that in the previous notification (Yes in Step S76). If the notified drop rate is not lower than that in the previous notification (No in Step S76), the drop rate characteristics measurement part 61 determines whether the set drop rate is the maximum drop rate in the drop rate characteristics table 32 (Step S77). If the set drop rate is the maximum drop rate in the drop rate characteristics table 32 (Yes in Step S77), the drop rate characteristics measurement part 61 ends the processing.

If the set drop rate is not the maximum drop rate in the drop rate characteristics table 32 (No in Step S77), the drop rate characteristics measurement part 61 records the acquired data in the drop rate characteristics table 32 (Step S78). The drop rate characteristics measurement part 61 further increases the drop rate set in the drop rate control part 62 and proceeds back to Step S72 (Step S79).

Note that the processing illustrated in FIG. 17 is merely an example and may be modified according to the implementation. For example, a modification may be made such that even if the result of the determination in Step S76 or Step S77 is affirmative, the drop rate characteristics measurement part 61 records information on the acquired drop rate and transport throughput in the drop rate characteristics table 32.

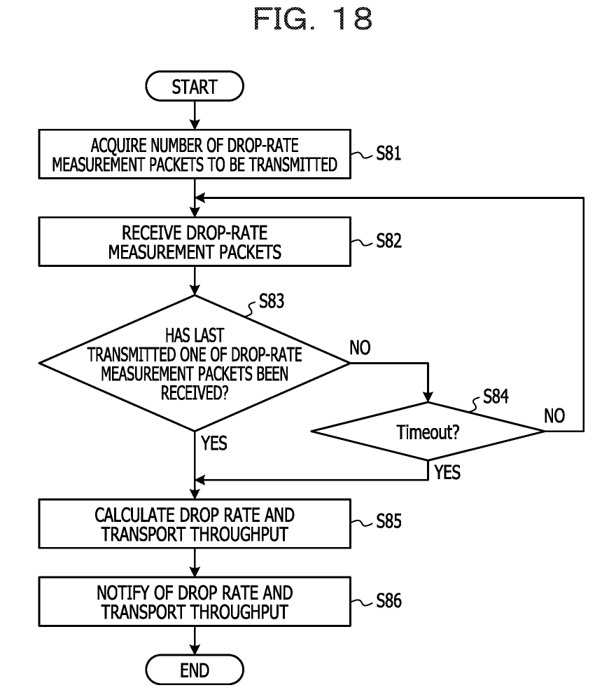

FIG. 18 is a flowchart illustrating an example of processing performed by the receiving communication apparatus 60. The drop rate characteristics measurement part 72 acquires the number of drop-rate measurement packets from a control packet received from the transmitting communication apparatus 60 (Step S81). The network interface 11 receives drop-rate measurement packets (Step S82). The drop rate characteristics measurement part 72 acquires data in the drop-rate measurement packets. The drop rate characteristics measurement part 72 determines whether the last transmitted one of the drop-rate measurement packets has been received (Step S83). If the last transmitted one of the drop-rate measurement packets has not been received (No in Step S83), the drop rate characteristics measurement part 72 determines whether a timeout for waiting for drop-rate measurement packets has been reached (Step S84). If the timeout for waiting for drop-rate measurement packets has yet to be reached (No in Step S84), the drop rate characteristics measurement part 72 proceeds back to Step S82.

If the last transmitted one of the drop-rate measurement packets has been received (Yes in Step S83), the drop rate characteristics measurement part 72 finds a drop rate and transport throughput using the drop-rate measurement packets received (Step S85). The drop rate characteristics measurement part 72 then notifies the transmitter of the drop-rate measurement packets of the drop rate and the transport throughput (Step S86). Also when determining in Step S84 that the timeout for waiting for drop-rate measurement packets has been reached (Yes in Step S84), the drop rate characteristics measurement part 72 proceeds to Step S85.

According to the third embodiment described above, the drop rate characteristics table 32 is updated autonomously by the communication apparatus 60 in events such as activation. Thus, the drop rate characteristics table 32 is created based on actual measurements carried out using communications between the communication apparatuses that are going to actually transmit and receive packets. The third embodiment saves processing in which an operator uses another system or the like to simulate communications between communication apparatuses and generate the drop rate characteristics table 32 beforehand.

### Fourth Embodiment

As a fourth embodiment, a description is given of a case where a data-receiving communication apparatus calculates a transmission rate and notifies a transmitting communication apparatus of the transmission rate.

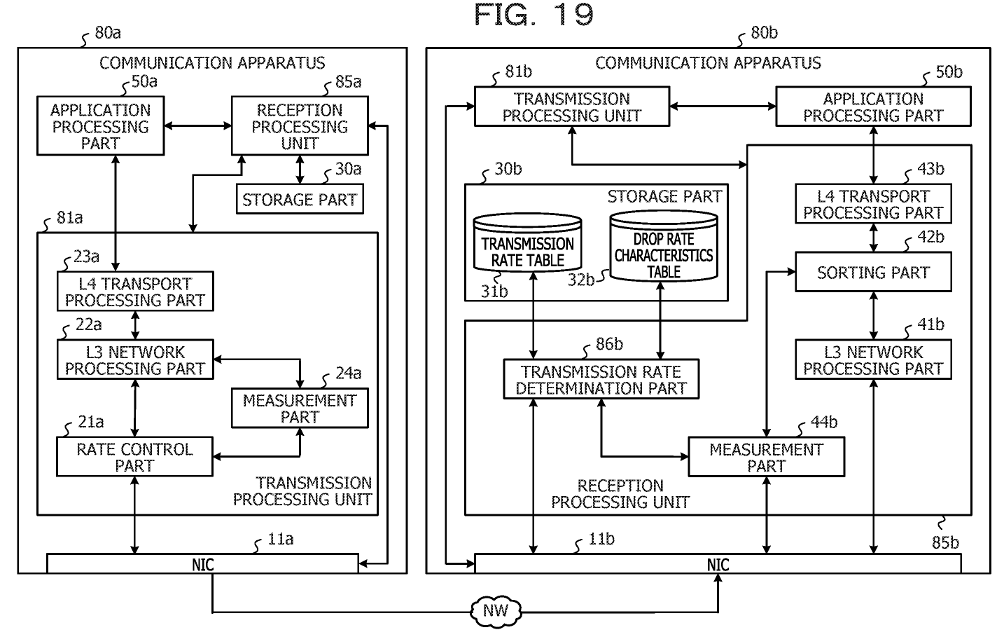

FIG. 19 is a diagram illustrating an example configuration of a communication apparatus used in the fourth embodiment. A communication apparatus 80 includes a transmission processing unit 81, a reception processing unit 85, the application processing part 50, the storage part 30, and the network interface 11. In FIG. 19, details of the transmission processing unit 81 are depicted within the communication apparatus 80a, and details of the reception processing unit 85 are depicted within the communication apparatus 80b. The transmission processing unit 81 and the reception processing unit 85 are implemented by the processor 101.

The transmission processing unit 81 includes the rate control part 21, the L3 network processing part 22, the L4 transport processing part 23, and the measurement part 24. The reception processing unit 85 includes the L3 network processing part 41, the sorting part 42, the L4 transport processing part 43, the measurement part 44, and a transmission rate determination part 86.

The transmission rate determination part 86 requests the measurement part 44 to start measuring the maximum value BWava of a transmission rate usable as appropriate, without causing packet loss between the communicating communication apparatuses 80. It is assumed here that the transmission rate determination part 86 has beforehand acquired information on a communication-partner communication apparatus 80 which is to be requested to transmit data. The transmission rate determination part 86 also calculates the performance-limit drop rate Pₗᵢₘ using the drop rate characteristics table 32. The performance-limit drop rate Pₗᵢₘ is calculated in the same manner described with reference to FIGS. 7 and 8.

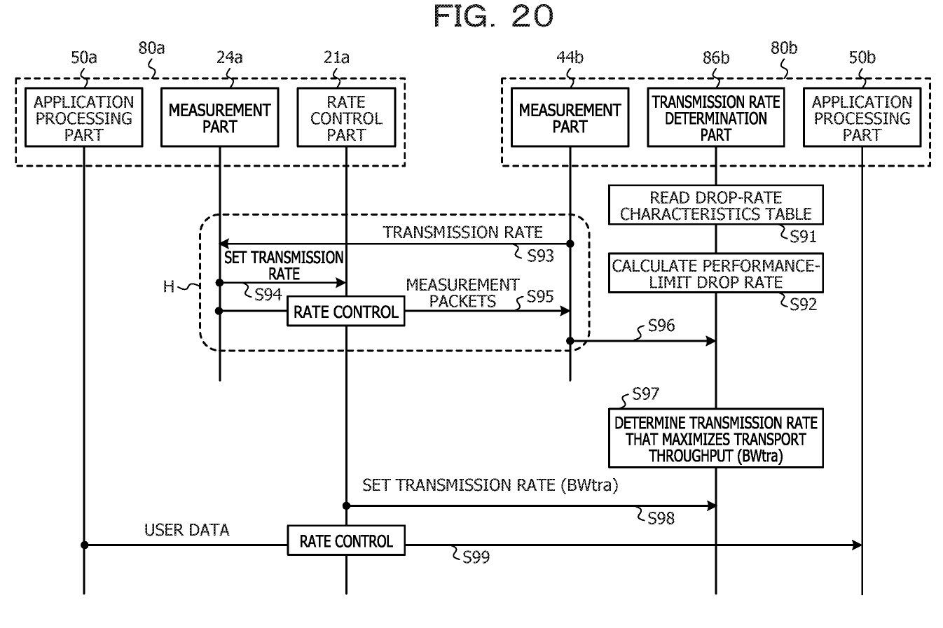

In response to the request from the transmission rate determination part 86, the measurement part 44 notifies the communication-partner communication apparatus 80 that the maximum value BWava of a transmission rate usable without causing packet loss is started to be measured. With reference to FIG. 20, an example communication method is described below.

FIG. 20 is a sequence diagram illustrating a communication method according to the fourth embodiment. The transmission rate determination part 86b in the data-packet-receiving communication apparatus 80b reads the drop rate characteristics table 32b (Step S91) and calculates a performance-limit drop rate (Step S92). Further, the transmission rate determination part 86b requests the measurement part 44b to start measuring the maximum value BWava of a transmission rate usable without causing packet loss between the communicating communication apparatuses 80.

The measurement part 44b performs processing for transmitting a control packet to the communication-partner communication apparatus 80a, the control packet notifying of a transmission rate to be used in the transmission of measurement packets (Step S93). The measurement part 24a sets the transmission rate included in the control packet in the rate control part 21a (Step S94). To the L3 network processing part 22a, the measurement part 24a outputs payload to be included in the measurement packets and information identifying the communication apparatus 80b as the destination of the measurement packets. The L3 network processing part 22a generates the measurement packets and outputs them to the rate control part 21a. The rate control part 21a transmits the packets inputted from the L3 network processing part 22a to the communication apparatus 80b at the transmission rate set by the measurement part 24a (Step S95).

The sorting part 42b of the communication apparatus 80b acquires the measurement packets via the network interface 11b and the like, and then outputs the measurement packets to the measurement part 44b. The measurement part 44b measures the reception rate of the measurement packets and then compares the reception rate with the transmission rate of which the measurement part 44b has notified the communication apparatus 80a. Using a result of the comparison processing, the measurement part 44b determines a transmission rate to be used in the next measurement and proceeds back to Step S93 as appropriate. The processing denoted as H in FIG. 20 is iterated until the maximum value BWava of a transmission rate usable without causing packet loss is found.

Once the maximum value BWava of a transmission rate usable without causing packet loss is found, the measurement part 44b of the communication apparatus 80b outputs the maximum transmission rate BWava thus found to the transmission rate determination part 86b (Step S96). Using the BWava obtained from data in a control packet and the performance-limit drop rate Pₗᵢₘ, the transmission rate determination part 86b determines a transmission rate that maximizes the transport throughput (BWtra) (Step S97). The transmission rate determination part 86b generates a control packet notifying of the value obtained as the transmission rate that maximizes the transport throughput (BWtra) and transmits the control packet to the communication apparatus 80a via the network interface 11b (Step S98).

The rate control part 21a of the communication apparatus 80a acquires, via the reception processing unit 85a and the like, the transmission rate (BWtra) notified of through the control packet. The rate control part 21a sets the acquired transmission rate as a transmission rate to be used in transmission of data packets to the communication apparatus 80b. Thereafter, the application processing part 50a generates data for the communication apparatus 80b. Data packets are generated by processing performed by the L4 transport processing part 23a and the L3 network processing part 22a. The L3 network processing part 22a outputs the data packets to the rate control part 21a, and the rate control part 21a transmits the data packets to the communication apparatus 80b at the set transmission rate (BWtra).

According to the fourth embodiment described above, the data-packet-receiving communication apparatus 80b may notify the data-packet-transmitting communication apparatus 80a of the transmission rate to be used in transmission of data packets to the communication apparatus 80b. Thus, the transmitting communication apparatus 80a does not have to determine the transmission rate for data packets for every communication partner. The fourth embodiment may thus be used to lessen the load on the transmitting communication apparatus 80. For example, when the transmitting communication apparatus 80a is a server apparatus and is to transmit data to a plurality of terminals, it is desirable to lessen the load on the transmitting apparatus 80. The fourth embodiment may be suitably applied to such a case.

### Other Embodiments

The above embodiments are not restrictive and may be modified variously. The following are some examples of such modification.

The formats of the tables and packets described above are mere examples, and may be changed according to the implementation.

Although the communication apparatus 80 does not update the drop rate characteristics table 32 in the example described in the fourth embodiment for simplicity description, the communication apparatus 80 may generate the drop rate characteristics table 32 in the fourth embodiment as well, as in the third embodiment.

Although the example of how to calculate the maximum value of a transmission rate causing no packet loss has been described with reference to FIG. 13, processing depicted in FIG. 13 is merely an example. For instance, the communication apparatus (10, 60, 80) may set a high transmission rate to an initial value and gradually decrease the transmission rate until the transmission rate equals the reception rate. The communication apparatus (10, 60, 80) may set the transmission rate equaling the reception rate to the maximum value BWava of a transmission rate causing no packet loss. Further, the communication apparatus (10, 60, 80) may transmit measurement packets using different rates and search for BWava by binary searching. In this case, if the transmission rate is higher than the reception rate, the communication apparatus (10, 60, 80) decreases the transmission rate and re-transmits measurement packets, thereby updating the upper limit of the transmission rate. If the transmission rate is equal to the reception rate, the communication apparatus (10, 60, 80) increases the transmission rate and re-transmits measurement packets, thereby updating the lower limit of the transmission rate. The communication apparatus (10, 60, 80) may find BWava by iterating the above processing until the difference between the upper limit and the lower limit of the transmission rate falls within a predetermined error range.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication apparatus configured to transmit packets including data to another communication apparatus, the communication apparatus comprising:
a memory configured to store relation information indicating a plurality of relationships between a plurality of packet loss rates at the another communication apparatus and a plurality of throughputs of the data included in the packets at the another communication apparatus; and
a processor coupled to the memory and configured to:
determine a first transmission rate of the packets transmitted from the communication apparatus to the another communication apparatus, a receiving rate of the packets at the another communication apparatus being a maximum value without a packet loss when the communication apparatus transmits the packets at the first transmission rate,
based on the relation information, select a packet loss rate among the plurality of packet loss rates, the throughput of the data corresponding to the selected packet loss rate being under a threshold,
based on the first transmission rate and the selected packet loss rate, determine a second transmission rate higher than the first transmission rate, and
transmit the packets from the communication apparatus to the another communication apparatus at the second transmission rate.

2. The communication apparatus according to claim 1, wherein
the plurality of relationships are determined based on a type of error correction processing for packet loss according to a protocol used for communications between the communication apparatus and the another communication apparatus.

3. The communication apparatus according to claim 2, wherein
the second transmission rate is a maximum transmission rate at which data included in a packet not received by the another communication apparatus due to the packet loss are restorable by the error correction processing.

4. The communication apparatus according to claim 1, wherein
the processor is configured to:
select, as the packet loss rate, a maximum rate of packet loss at which the decrease in the throughput of the data reaches the threshold, and
determine, as the second transmission rate, a transmission rate at which the rate of packet loss is the maximum rate of the packet loss.

5. The communication apparatus according to claim 4, wherein the processor is further configured to:
execute a drop process on at least one packet among the packets, based on the packet loss rate,
notify the another communication apparatus of a number of the packets transmitted before the drop process,
transmit the packets after the drop process to the another communication apparatus,
determine a characteristic of an error correction processing by acquiring throughput of data of the transmitted packets from the another communication apparatus,
determine the maximum rate of the packet loss, and
determine, as the second transmission rate, a transmission rate at which the rate of the packet loss is the maximum rate of the packet loss.

6. The communication apparatus according to claim 1, wherein
a packet among the packets includes a payload and a header portion,
the data is included in the payload, and
the throughput of the data is determined based on the data other than the header portion.

7. A communication apparatus configured to receive packets including data transmitted from another communication apparatus, the communication apparatus comprising:
a memory configured to store relation information indicating a plurality of relationships between a plurality of packet loss rates at the communication apparatus and a plurality of throughputs of the data included in the packets at the communication apparatus; and
a processor coupled to the memory and configured to:
determine a first transmission rate of the packets transmitted from the another communication apparatus to the communication apparatus, a receiving rate of the packet at the communication apparatus being a maximum value without a packet loss when the another communication apparatus transmits the packet at the transmission rate of the first transmission rate,
select, based on the relation information, a packet loss rate from the plurality of packet loss rates, the selected packet loss rate indicating a decrease in the throughput of the data corresponding to the selected packet loss rate being under a threshold,
determine, based on the first transmission rate and the selected packet loss rate, a second transmission rate higher than the first transmission rate, and
notify the another communication apparatus of the second transmission rate to transmit the packets at the second transmission rate.

8. The communication apparatus according to claim 7, wherein
the plurality of relationships are determined based on a type of error correction processing for packet loss according to a protocol used for communications between the another communication apparatus and the communication apparatus.

9. The communication apparatus according to claim 8, wherein
the second transmission rate is a maximum transmission rate at which the data included in the packet not received by the communication apparatus due to the packet loss are restorable by the error correction processing.

10. The communication apparatus according to claim 7, wherein
the processor is configured to:
select, as the packet loss rate, a maximum rate of packet loss at which the decrease in the throughput of the data reaches the threshold, and
determine, as the second transmission rate, a transmission rate at which the packet loss rate is the maximum rate of the packet loss.

11. The communication apparatus according to claim 7, wherein
a packet among the packets includes a payload and a header portion,
the data is included in the payload, and
the throughput of the data is determined based on the data other than the header portion.

12. A method of communication using a first communication apparatus and a second communication apparatus, the first communication apparatus being configured to transmit packets to the second communication apparatus, the method comprising:
obtaining, by the first communication apparatus, relation information indicating a plurality of relationships between a plurality of packet loss rates at the second communication apparatus and a plurality of throughputs of data included in the packets at the second communication apparatus;
determining, by the first communication apparatus, a first transmission rate of a packet among the packets transmitted from the first communication apparatus to the second communication apparatus, a receiving rate of the packet at the second communication apparatus being a maximum value without a packet loss when the first communication apparatus transmits the packet at the first transmission rate;
selecting, by the first communication apparatus, based on the relation information, a packet loss rate from the plurality of rates of packet loss, the selected packet loss rate indicating a decrease in the throughput of the data corresponding to the selected packet loss rate being under a threshold;
determining, by the first communication apparatus, based on the first transmission rate and the selected packet loss rate, a second transmission rate higher than the first transmission rate; and
transmitting the packets from the first communication apparatus to the second communication apparatus, at the second transmission rate.

13. The method according to claim 12, wherein
the plurality of relationships are determined based on a type of error correction processing for packet loss according to a protocol used for communications between the first communication apparatus and the second communication apparatus.

14. The method according to claim 13, wherein
the second transmission rate is a maximum transmission rate at which data included in the packet not received by the second communication apparatus due to the packet loss are restorable by the error correction processing.

15. The method according to claim 12 wherein
in the selecting, the first communicate apparatus selects, as the packet loss rate, a maximum rate of packet loss at which the decrease in the throughput of the data reaches the threshold, and
in the determining of the second transmission rate, the first communicate apparatus determines, as the second transmission rate, a transmission rate at which the packet loss rate is the maximum rate of the packet loss.

16. The method according to claim 15 further comprising:
executing, by the first communication apparatus, a drop process on at least one packet among the packets, based on a packet loss rate;
notifying, by the first communication apparatus, the second communication apparatus of a number of the packets before the drop processing;
transmitting, by the first communication apparatus, the packets after the drop processing to the second communication apparatus;
determine, by the first communication apparatus, a characteristic of an error correction processing by acquiring the throughput of the data from the second communication apparatus; and
determining, by the first communication apparatus, the maximum rate of the packet loss, wherein
in the determining of the second transmission rate, the first communication apparatus determines, as the second transmission rate, the transmission rate at which the rate of the packet loss is the maximum rate of the packet loss.
